(19) United States
(12) Patent Application Publication
(10) Pub. No.: US 2004/0055448 A1
(43) Pub. Date: Mar. 25, 2004

(54) Music providing system having music selecting function by human feeling and a music providing method using thereof

(76) Inventor: Gi-Man Byon, Seoul (KR)

Correspondence Address: Don W Bulson, Renner Otto Boisselle & Sklar, 19th Floor, 1621 Euclid Avenue, Cleveland, OH, 44115, US

(21) Appl. No.: 10/450,728

(22) PCT Filed: Dec. 14, 2001
(86) PCT No.: PCT/KR01/02174

(30) Foreign Application Priority Data
Dec. 15, 2000 (KR) 2000/76948

(51) Int. Cl. G10H 7/00; G10H 1/02; G01P 3/00

(52) U.S. Cl. 84/626

(57) ABSTRACT

A music provision system having a music selection function based on human feelings, which is capable of analyzing a user's feeling on the basis of user personal information, user taste information and external information affecting the user's feeling, or a human feeling check list provided to the user, outputting the analysis results as a feeling type and feeling level and providing music corresponding to the feeling type and level. A music player having a function of recognizing a user's feeling is also disclosed herein. The music player can reproduce music corresponding to the user's feeling by itself.

### TECHNICAL FIELD

The present invention relates to a music provision system, and more particularly to a music provision system having a music selection function based on human feelings and a music provision method using the same, wherein music is selected according to human feelings, thereby enabling a user to always be provided with music appropriate to his/her feelings so that his/her feelings can be purified.

### BACKGROUND ART

With the advance of digital techniques, audio recording/reproduction systems have recently been gradually changed from a type where music is recorded and reproduced on/from an LP or magnetic tape to a type where music is converted into digital data and then stored and reproduced in/from a CD or MD. At the present, the CD or MD dominates the audio recording/reproduction systems in that it provides consistent quality of sound because the music is stored in the form of digital data and it is permanently useable.

However, the CD or MD has a limitation in use because it provides only tunes stored therein to a user. In order to overcome this problem with the CD or MD, an MPEG Layer3 (MP3) play system has recently been rapidly spread, in which a PC user compresses digital music data using an MP3 algorithm and reproduces the resulting MP3 file using an MP3 player to listen to music of the MP3 file.

The MP3 play system is advantageous in that a large number of tunes are storable in a computer, particularly in the form of compressed files, while occupying a small part of the storage capacity of the computer.

In particular, a portable MP3 player has recently been widely popularized in that it can download MP3 files from a computer and store a large number of tunes therein, so that a user can easily search for, select and listen to a desired tune.

However, a variety of players proposed up to now, including the above-mentioned MP3 player, have no function of analyzing a user's feeling at a music listening time, and actively providing the user with music appropriate to his/her feeling to purify his/her feeling or divert himself/herself, besides a simple function of selecting and playing music.

### DISCLOSURE OF THE INVENTION

Therefore, the present invention has been made in view of the above problems, and it is an object of the present invention to provide a music provision system having a music selection function based on human feelings and a music provision method using the same, wherein a user's feeling is analyzed and music appropriate to the analyzed feeling is provided to the user, so as to purify his/her feeling or divert himself/herself.

In accordance with one aspect of the present invention, the above and other objects can be accomplished by the provision of a music player for playing music based on human feelings. The music player comprises: an input unit for receiving parallel digital music data; a storage unit for storing the parallel digital music data received by the input unit; a human feeling judger for providing a human feeling check list to a user and judging the user's current feeling by the results of the human feeling check list checked off by the user; a music selector for selecting music corresponding to the user's feeling judged by the human feeling judger; a format converter for converting parallel digital data of the music selected by the music selector into serial digital data; a decoder for decoding the serial digital data converted by the format converter; a digital/analog (D/A) converter/amplifier unit for converting output digital music data from the decoder into analog music data and amplifying the converted analog music data; and an output unit for outputting the analog music data converted and amplified by the D/A converter/amplifier unit.

In accordance with another aspect of the present invention, there is provided a music provision system for providing music based on a user's feelings to a music player of the user over the Internet. The music provision system comprises: a human feeling judger for judging the user's current feeling by user personal information and user taste information; a music selector for selecting music corresponding to the user's feeling judged by the human feeling judger; a database unit for storing the user personal information and user taste information and music information and providing the stored information to the human feeling judger and music selector; and a main control unit for controlling the entire system and sending data of the music selected by the music selector to the user over the Internet.

In a feature of the present invention, there is provided a music player capable of selecting music based on human feelings. Any existing player is applicable as such a music player. But, in the present invention, an MP3 player which stores and reproduces music as digital data, or MP3 files, will be most appropriate in consideration of music classification or automatic music selection based on human feelings.

Human feeling judgment is performed by providing a check list for a psychology test or character trait test to a user. If the user checks off items in the provided check list according to his/her current feeling, a human feeling judger judges the user's current feeling by the checked-off items and outputs the judgment results metrically as a feeling type and feeling level. A music list corresponding to the feeling type and level is provided to the user such that he/she selects desired music from the provided music list. As a result, the user can listen to the desired music.

In another feature of the present invention, there is provided a music provision system which, if a user provides basic information regarding his/her feeling, performs a metrical analysis of the user's feeling, selects music on the basis of the analysis results and provides the selected music to the user over the Internet.

A Web server accessible via the Internet stores personal information and interests of members. The Web server analyzes a member's feeling on the basis of a variety of external information having effects on human feelings, such as weather information, the member's biorhythm, news on the member's interests and so forth, and outputs the analysis results metrically as a feeling type and feeling level. The Web server then provides music appropriate to the feeling type and level to the member.

The Web server further provides a Web page including a human feeling check list. Therefore, the Web server can actively provide music appropriate to a user's current feeling by analyzing his/her feeling directly.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the construction of a music player having a music selection function based on human feelings in accordance with the present invention;

FIG. 2 is a flow chart illustrating the operation of the music player in accordance with the present invention;

FIG. 3 is a block diagram showing the construction of a music provision system having the music selection function based on the human feelings in accordance with the present invention;

FIG. 4 is a block diagram of a Web server in FIG. 3;

FIG. 5 is a view showing the structure of a database unit in FIG. 4;

FIG. 6 is a flow chart illustrating a preferred embodiment of a music provision method based on human feelings in accordance with the present invention; and

FIG. 7 is a flow chart illustrating an alternative embodiment of the music provision method based on human feelings in accordance with the present invention.

### BEST MODE FOR CARRYING OUT THE INVENTION

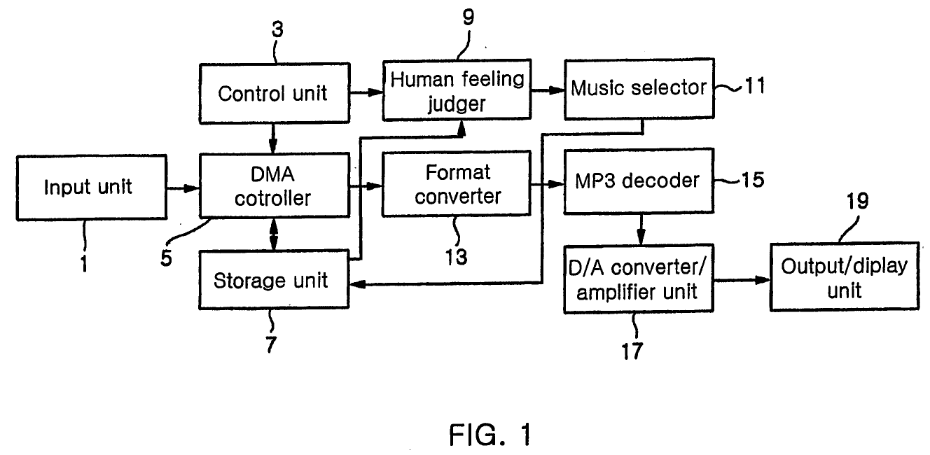

With reference to FIG. 1, there is shown in block form the construction of a music player, preferably an MP3 player, having a music selection function based on human feelings in accordance with the present invention.

As shown in FIG. 1, the MP3 player of the present invention comprises an input unit 1 connected to a computer or the like for receiving MP3 files, which are parallel digital data compressed according to the MPEG standard. The digital data received by the input unit 1 is inputted to a DMA controller 5, which removes a certain amount of the inputted digital data if it is a duplicate of the previous readings, and then stores the resulting nonduplicate data in a storage unit 7. Under control of a control unit 3, output parallel digital data from the DMA controller 5 is converted into serial digital data by a format converter 13 and then decoded by an MP3 decoder 15.

A digital/analog (D/A) converter/amplifier unit 17 also functions under control of the control unit 3 to convert output serial digital data from the decoder into analog music data and amplify the converted analog music data. The amplified music data is then outputted through an output/display unit 19. Typically, such digital music data contains various information (for example, music explanations) about music as well as audio data of the music. In this regard, the output/display unit 19 not only outputs music, but also displays information about the music. A liquid crystal display (LCD) window is generally installed in the MP3 player to display the music information thereon.

Besides the above-described basic components of the existing MP3 player, the present MP3 player further comprises a human feeling judger 9 for judging human feelings, and a music selector 11 for selecting music corresponding to the human feelings judged by the human feeling judger 9.

The human feeling judger 9 provides a human feeling check list stored in the storage unit 7 through the LCD window. If a user selects items corresponding to his/her feeling from the displayed check list, then the human feeling judger 9 judges the user's feeling by measuring a type and level of the feeling on the basis of the selected items.

The MP3 files inputted through the input unit 1 are stored in the storage unit 7 while being classified according to music genres. When the MP3 files are stored in the storage unit 7, the control unit 3 classifies the MP3 files according to genres, tones and rhythms and lyrics of music corresponding respectively thereto such that they match types and levels of human feelings, respectively. This classification can be predefined by the user or a specialist in consideration of music characteristics.

Upon receiving the type and level measurements of the user's current feeling judged by the human feeling judger 9, the music selector 11 selects and plays an MP3 file corresponding to the received type and level measurements from among the MP3 files stored in the storage unit 7.

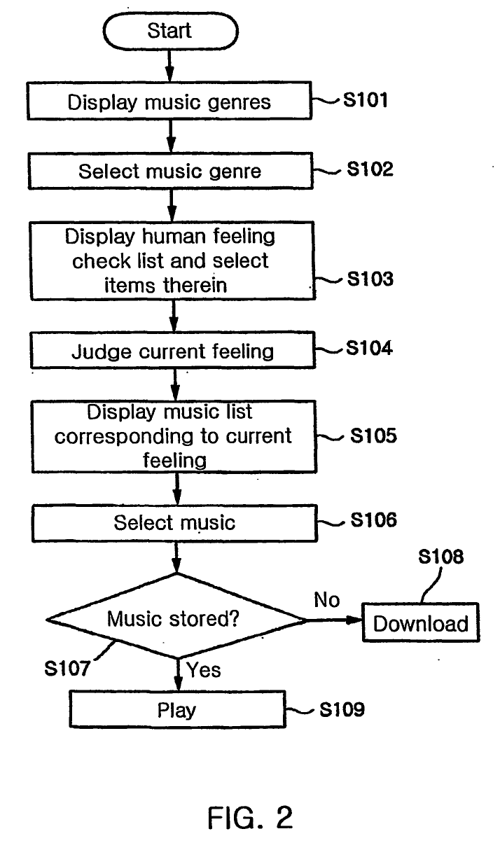

FIG. 2 is a flow chart illustrating the operation of the MP3 player of FIG. 1.

First, if the user turns on the MP3 player, then music genres are displayed on the LCD window of the MP3 player (S101). The user selects a desired one of the music genres displayed on the LCD window (S102). As stated previously, the MP3 files are stored in the storage unit 7 of the MP3 player while being classified according to all music genres including pop, rock & roll, classical world music, folk and others. In this connection, the user can select any desired music genre.

Thereafter, the user selects items corresponding to his/her feeling while viewing the human feeling check list supplied from the storage unit 7 and displayed on the LCD window (S103). The human feeling check list may be similar to a check list used for a general psychology test or character trait test. In the present invention, the human feeling check list is preferably drawn up by a specialist such as a psychologist, psychoanalyst or the like.

An example of the human feeling check list is shown in the following Table 1. It should be noted herein that this example is nothing but one embodiment provided for illustrative purposes of the invention, and a more detailed check list may be actually used in another embodiment.

TABLE 1

| | CHECK ITEMS | YES | NO | SOMETIMES |
|---|---|---|---|---|
| 1 | DO YOUR PROBLEMS KEEP | 0 | | |
| | YOU AWAKE? | | | |
| 2 | DO YOU THINK YOUR | | 0 | |
| | LIFESTYLE IS ABNORMAL? | | | |
| 3 | DO YOU WORRY MORE | | 0 | |
| | THAN MOST PEOPLE? | | | |
| 4 | DO YOU FALL ASLEEP | | | 0 |
| | EASILY AT NIGHT? | | | |
| 5 | ARE YOU RESTLESS? | | | 0 |
| 6 | DO YOU FEEL NERVOUS? | 0 | | |
| . . . | . . . | . . . | . . . | . . . |

If the items in the human feeling check list are checked off in the above manner by the user, then they are measured and accumulated as numerical values. Although not shown, human feelings are defined as levels in the present invention. For example, assuming the happiest feeling to be level 1, the most melancholy feeling may be defined as level 10. In this case, the feeling level gradually changes from level 1 to level 10, with the feelings becoming worse.

Points are assigned respectively to the checked-off items in the human feeling check list (for example, 2 points for YES, 0 points for NO, and 1 points for SOMETIMES) and then summed up. A feeling level corresponding to the summed-up point result represents the user's current feeling.

The human feeling judger 9 of the MP3 player judges the user's current feeling by measuring a type and level of the feeling on the basis of the calculated points of the checked-off items (S104).

Thereafter, the music selector 11 receives music corresponding to the type and level of the user's current feeling from the storage unit 7 and displays a list of the received music on the LCD window (S105). At this time, the displayed music list belongs to a music genre previously selected by the user.

Alternatively, all music may be displayed in the case where the user selects no music genre. As another alternative, although not shown, after the user's current feeling is judged, the user may be asked to select a desired music genre, and a music list corresponding to the desired music genre may be then displayed.

The user selects desired music from the music list displayed on the LCD window (S106). At this time, if an MP3 file of the music selected by the user is stored in the storage unit 7, it is played directly (S109). However, in the case where the MP3 file of the music selected by the user is not present in the storage unit 7, it is downloaded from the computer and then played (S108 and S109).

As described above, the music player (for example, the MP3 player) of the present invention can recognize the user's current feeling on the basis of the human feeling check list items personally checked off by the user and provide music appropriate to the recognized feeling to the user. In other words, when the user has a happy feeling, the music player provides cheerful music to the user so as to raise the happy feeling still more. On the contrary, when the user has a melancholy feeling, the music player provides calm music to the user so as to attenuate the melancholy feeling. In this manner, the present music player can provide music capable of controlling the user's feelings.

According to the present invention, a Web server can select music based on a user's feelings and provide the selected music to a computer or music player of the user over the Internet

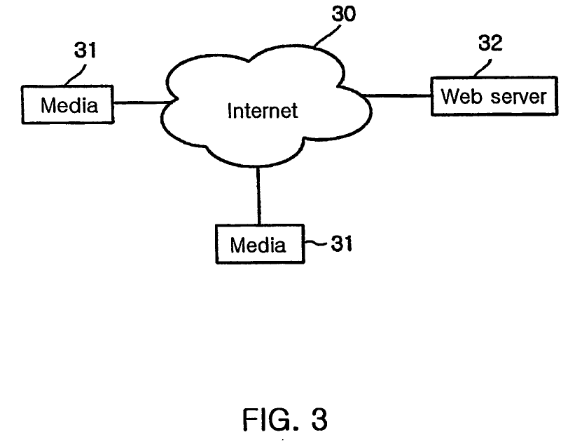

FIG. 3 shows the construction of such a music provision system having the music selection function based on the human feelings, which will hereinafter be described in detail.

As shown in FIG. 3, a Web server 32 is connected to the user's media 31 over the Internet 30. The Web server 32 is adapted to store a variety of music, select specific music based on the user's current feeling and provide the selected music to the user over the Internet. At this time, the music is mainly stored in the form of digital data, typically digital files such as MP3 files, MPEG files, AVI files or WAVE files.

Although a computer can be most widely used as the user's media, any music reproducible equipment connectable to the Internet (including a wireless Internet network), such as an MP3 player or cellular phone, may be used as the user's media

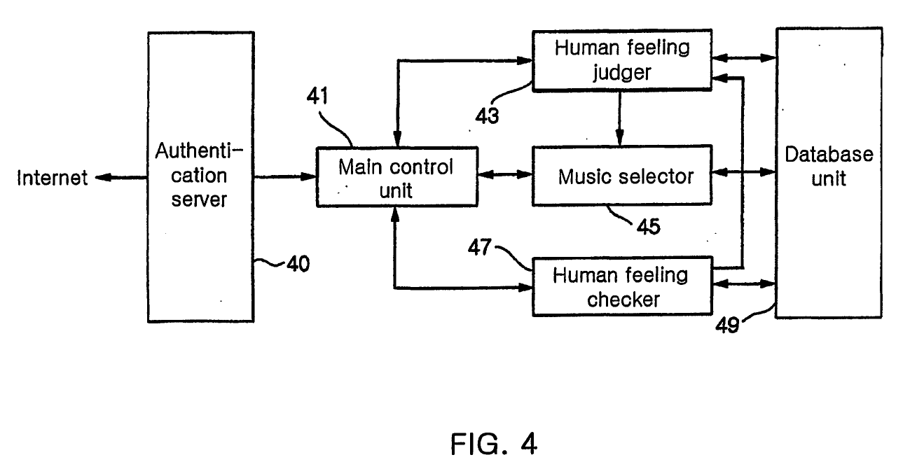

The Web server 32 includes, as shown in FIG. 4, an authentication server 40 for authenticating whether the user is an authorized one when he/she gains access to the Web server 32 over the Internet and authenticating a payment when a music file is downloaded or information is provided, a main control unit 41 for providing an initial Web page to the user when he/she gains access to the Web server 32 and controlling various components in the Web server 32, a human feeling judger 43 for judging human feelings under the control of the main control unit 41, a music selector 45 for selecting music appropriate to the human feelings judged by the human feeling judger 43, a human feeling checker 47 for providing a human feeling check list on a Web page and transferring the results of the check list personally checked off and sent by the user to the human feeling judger 43 such that the judger 43 judges the user's current feeling by a feeling type or level based on the transferred check list results, and a database unit 49 for storing a variety of information, such as user information, music files, the human feeling check list, etc., and providing the stored information to the human feeling judger 43, music selector 45 and human feeling checker 47.

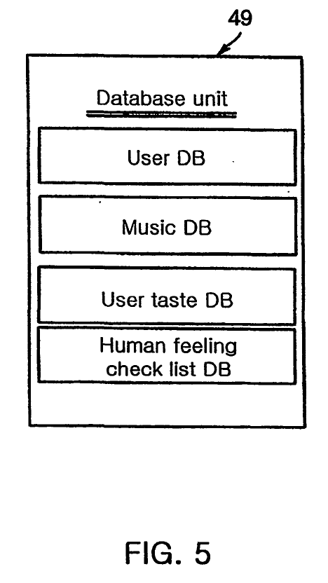

The database unit 49 includes, as shown in FIG. 5, a user database (DB) for storing a variety of personal information regarding the user, such as a user's name or identification (ID), password, address, etc., a music DB for classifying and storing music files according to music genres and feeling levels, a user taste DB for storing user taste information, such as the user's interests, biorhythm, hobbies, etc., and a human feeling check list DB for storing the human feeling check list. The user's current feeling can be analyzed on the basis of the results of the human feeling check list checked off by the user.

The human feeling judger 43 analyzes the user's current feeling. The human feeling judger 43 collects external information having effects on the user's feeling on the basis of the user personal information stored in the database unit 49 and analyzes the user's feeling on the basis of the collected information.

For example, assume that the user has an interest in investment in stocks and likes baseball. Provided that stock market prices fall and a favorite baseball team loses a match, the user's feeling will be analyzed as being bad. In the contrary case, the user's feeling will be analyzed as being good. Further, a variety of factors, such as the current weather, the user's biorhythm, current news and so forth, may be used to analyze the user's feeling.

Alternatively, the human feeling judger 43 may recognize the user's feeling directly. That is, the human feeling check list as shown in the Table 1 is displayed on a Web page sent to the user's computer over the Internet such that the user personally checks off the items provided on the check list, and the human feeling judger 43 judges the user's feeling by the results of the check list checked off by the user. Although this feeling judgment based on the human feeling check list is subjected to the procedures as shown in FIG. 2, it can provide more accurate results because the Web server presents more detailed items.

Next, a detailed description will be given of methods for providing music based on human feelings over the Internet as stated above.

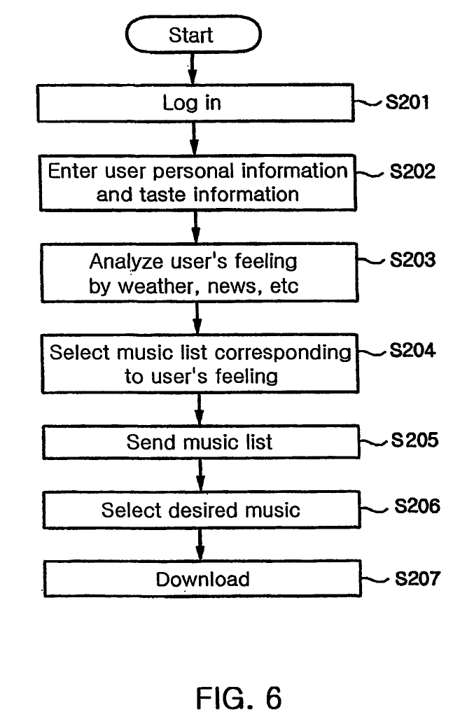

FIG. 6 is a flow chart illustrating a method for analyzing the user's feeling on the basis of the user taste information stored in the Web server and providing music in accordance with the analyzed result.

First, the user accesses the Web server over the Internet, and then logs in thereto by entering the user ID and password (S201). Typically, a general user as well as a member may gain access to the Web server. If the general user gains access to the Web server, he/she may access a variety of information provided from the Web server, for example, music information, sheet music, a best-seller list, etc. However, in order to download a music file, the general user has to pay a downloading fee according to a copyright law. For this reason, all users must be authenticated as members to receive music provided from the Web server.

After logging in to the Web server, the user enters his personal information and taste information (S202). Then, the Web server analyzes the user's feeling on the basis of the information entered by the user (S203). Namely, the Web server measures the user's feeling on the basis of various information, such as the user's biorhythm, current news on the user's interests, the user's financial standing and so forth, to analyze a level of the user's feeling.

Subsequently, the Web server sends a music list corresponding to the analyzed feeling level to the user (S205). If the user selects desired music from the sent music list (S206), then a file (for example, an MP3 file) of the selected music is automatically downloaded to the user (S207). At this time, the downloaded music file includes explanations of the corresponding music (for example, a composer, composition year, music introduction, etc.). As a result, the music explanations are displayed when the music file is played by the user.

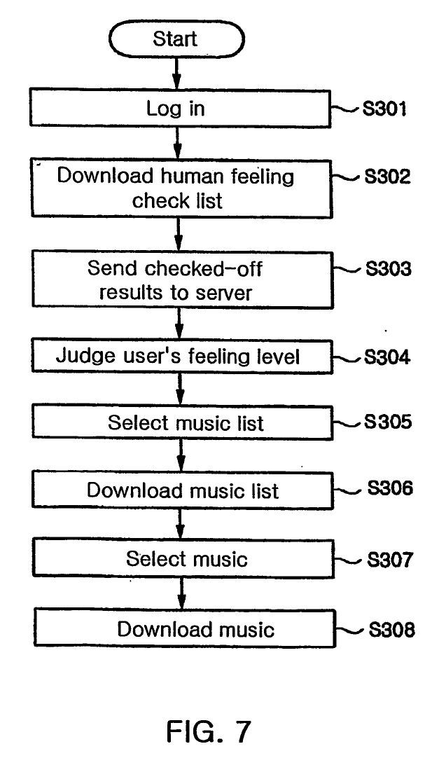

FIG. 7 is a flow chart illustrating a method for judging the user's feeling directly on the basis of the human feeling check list and providing music in accordance with the judged result. This method is similar to that executed in a music player such as the MP3 player shown in FIG. 2.

First, if the user accesses the Web server over the Internet and logs in thereto by entering the user ID and password (S301), then the Web server downloads a Web page including the human feeling check list to the user's computer (or other music player) (S302). In the present embodiment, although the human feeling check list provided from the Web server has the same format as that shown in the Table 1, it includes more detailed items.

Thereafter, the user checks off the items in the downloaded human feeling check list on the basis of his/her feeling and sends the checked-off results back to the Web server (S303). Then, the human feeling judger 43 in the Web server measures the user's current feeling on the basis of the results of the human feeling check list checked off and sent by the user to judge a level of the user's current feeling (S304).

Subsequently, the music selector 45 in the Web server selects a music list corresponding to the judged feeling level from the database unit 49 (S305), and the main control unit 41 in the Web server sends the music list selected by the music selector 45 to the user over the Internet (S306).

At this time, the music list may be sent while being classified according to music genres, composers or performers. If the user selects desired music from the sent music list (S307), then a file of the selected music is downloaded from the Web server to the user's computer (S308).

As described above, in the music provision system having the music selection function based on the human feelings according to the present invention, the Web server accessible via the Internet recognizes the user's current feeling and provides music appropriate to the recognized feeling.

In the most general terms, a computer is connectable to the Web server via a wired Internet network. Alternatively, a music player or cellular phone may be connected directly to the Web server via a wireless Internet network.

### INDUSTRIAL APPLICABILITY

As apparent from the above description, according to the present invention, means for analyzing human feelings is installed in a music player such as an MP3 player. Therefore, a user's current feeling is analyzed and music appropriate to the analyzed feeling is provided to the user, so as to purify his/her feeling.

Furthermore, a Web server accessible via the Internet recognizes the user's current feeling and provides music appropriate to the recognized feeling.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A music provision system based on human feelings, comprising:
a human feeling checker for providing a human feeling check list to a user over the Internet and receiving results of said human feeling check list checked off by the user;
a human feeling judger for judging the user's current feeling by said check list results received by said human feeling checker;
a music selector for selecting music corresponding to said user's current feeling judged by said human feeling judger;
a database unit for storing information regarding said human feeling check list and music information and providing the stored information to said human feeling judger, music selector and human feeling checker; and
a main control unit for controlling said human feeling checker, human feeling judger, music selector and database unit and sending data of said music selected by said music selector to said user over the Internet.

2. The music provision system as set forth in claim 1, wherein said database unit includes:
a user database for storing user information;
a music database for storing said music information; and
a human feeling check list database for storing said human feeling check list information.

3. The music provision system as set forth in claim 1, wherein said music data is an MP3 file, AVI file, MPEG file or WAVE file.

4. The music provision system as set forth in claim 1, wherein said music data includes explanations of said music selected by said music selector.

5. The music provision system as set forth in claim 1, wherein said Internet includes a wireless Internet network connected to a Web server.

6. The music provision system as set forth in claim 5, wherein said user gains access to said Web server through a computer, music player or cellular phone.

7. A music provision system based on human feelings, comprising:
a human feeling judger for judging a user's current feeling by user personal information, user taste information and external information having effects on the user's feeling;
a music selector for selecting music corresponding to said user's feeling judged by said human feeling judger;
a database unit for storing said user personal information and user taste information and music information and providing the stored information to said human feeling judger and music selector; and
a main control unit for controlling said human feeling judger, music selector and database unit and sending data of said music selected by said music selector to said user over the Internet.

8. The music provision system as set forth in claim 7, wherein said user personal information includes said user's biorhythm information.

9. The music provision system as set forth in claim 7, wherein said user taste information includes said user's hobbies, interests and/or financial standing.

10. A music provision method based on human feelings, comprising the steps of:
a) logging in to a Web server by entering a user identification and password, and then downloading a Web page from said Web server;
b) entering user personal information and user taste information on the downloaded Web page to send said information to said Web server;
c) analyzing a user's current feeling on the basis of said user personal information and user taste information and external information having effects on the user's feeling and outputting the analysis results as a type and level of said user's current feeling; and
d) selecting music corresponding to said feeling type and level and providing data of the selected music to said user.

11. The music provision method as set forth in claim 10, wherein said step d) includes the steps of:
d-1) selecting a music list corresponding to said feeling type and level and sending the selected music list to said user over the Internet;
d-2) allowing said user to select desired music from the sent music list; and
d-3) sending data of said music selected by said user thereto.

12. A music provision method based on human feelings, comprising the steps of:
a) logging in to a Web server by entering a user identification and password, and then downloading a Web page including a human feeling check list from said Web server;
b) allowing a user to check off items provided on said human feeling check list of the downloaded Web page according to his/her current feeling and send the checked-off results to said Web server;
c) analyzing the user's current feeling on the basis of said checked-off human feeling check list results and outputting the analysis results as a type and level of said user's current feeling;
d) selecting music corresponding to said feeling type and level; and
e) sending data of the selected music to said user over the Internet.

13. A music player having a music selection function based on human feelings, comprising:
an input unit for receiving parallel digital music data;
a storage unit for storing the parallel digital music data received by said input unit;
a human feeling judger for providing a human feeling check list to a user and judging the user's current feeling by the results of said human feeling check list checked off by said user;
a music selector for selecting music corresponding to said user's feeling judged by said human feeling judger;
a format converter for converting parallel digital data of said music selected by said music selector into serial digital data;
a decoder for decoding the serial digital data converted by said format converter;
a digital/analog (D/A) converter/amplifier unit for converting output digital music data from said decoder into analog music data and amplifying the converted analog music data; and
an output unit for outputting the analog music data converted and amplified by said D/A converter/amplifier unit.

14. The music player as set forth in claim 13, wherein said storage unit is adapted to store said human feeling check list and provide it to said user through said human feeling judger.
